(19) United States
(12) Patent Application Publication
(10) Pub. No.: US 2015/0085846 A1
(43) Pub. Date: Mar. 26, 2015

(54) RADIO ACCESS METHOD FOR REDUCING ROUTING OVERHEAD IN COGNITIVE RADIO ADHOC NETWORKS

(71) Applicants: AJOU University Industry-Academic Cooperation Foundation, Suwon-si (KR); Electronics and Telecommunications Research Institute, Daejeon (KR)

(72) Inventors: Cheolhyo LEE, Daejeon (KR); Kyung-yul CHEON, Daejeon (KR); Chang-Joo KIM, Daejeon (KR); Young-Bae XO, Suwon-si (KR); Jaebeom KIM, Suwon-si (KR)

(21) Appl. No.: 14/072,874

(22) Filed: Nov. 6, 2013

(30) Foreign Application Priority Data
Sep. 23, 2013 (KR) 10-2013-0112587

(51) Int. Cl. H04W 40/24

(52) U.S. Cl. CPC H04W 40/244; H04W 84/18
USPC 370/338

(57) ABSTRACT

A radio access method for use in a radio access device in cognitive radio ad-hoc networks, the radio access method comprising: comparing additional information about neighboring radio access devices, which exist in the cognitive radio ad-hoc networks, in a second layer of the radio access device with additional information about the neighboring radio access devices in a third layer of the radio access device in the cognitive radio ad-hoc networks; and generating a routing control message when the additional information of the second layer is different from the additional information of the third layer to broadcast the routing control message.

### RELATED APPLICATIONS

This application claims the benefit of Korean Patent Application No. 10-2013-0112587, filed on Sep. 23, 2013, which is hereby incorporated by reference as if fully set forth herein.

### FIELD OF THE INVENTION

The present invention relates to a technique to reduce broadcasting routing control messages in a radio cognitive radio ad-hoc network environment, and more particularly, to a radio access method adapted for reducing broadcasting of routing control messages occurred when individual radio access device search for neighboring radio access devices or selects routes.

### BACKGROUND OF THE INVENTION

The periodic broadcasting of a control message to is a method that is commonly used in all of mobile routing technologies making use of an LSR (Link State Routing) scheme, which is employed to select a route to neighboring radio access devices existing on a network.

For example, OLSR (Optimized Link State Routing) protocol suggested on RFC 3626 searches for neighboring radio access devices by periodically broadcasting a HELLO message and selects a route based on the search. In standard OLSR, every two second cycle is basically assigned to the time to broadcast the hello message, and thus, entire radio access devices on the network are adapted to periodically send the HELLO message. By periodically exchanging Hello messages, each of the radio access devices on the network registers neighboring radio access devices that are searched in its neighboring radio access device information, and establishes a route to a destination by utilizing the information.

The period of generating the control message is a key factor that determines the accuracy of the neighboring radio access device information. If the transmission period time occupies a relatively long time, it causes to lower the sensitivity of the search of neighboring radio access devices. Nonetheless, the number of generations of control messages decreases accordingly, reducing the transmission overhead of the control message. In contrast, a relatively short transmission period leads to an increase of the sensitivity of the search of neighboring radio access devices, so that the connectivity due to the movement or change of the neighboring radio access devices can be rapidly recognized and can be reflected in the selection of the route. However, the short period increases the [symbol] amount of generation of control messages, thereby increasing the transmission overhead of the control messages in the network. In particular, broadcast of the control messages is scheduled to be transmitted via whole interfaces in each radio access device, and thus the amount of the overall messages increases in proportion to the number of the interfaces in each radio access device.

The overhead of the control messages in mobile ad-hoc networks together with the broadcast of the messages of the routing protocol cause a greater problem in a cognitive radio network environment. In the cognitive radio network environment, each radio access device broadcasts a beacon message on a regular basis in a network layer 2 (MAC layer) in order to exchange available channel information with neighboring radio access devices. For example, in IEEE 802.22, the beacon message is defined to contain a MAC address, location, auxiliary channel information of its corresponding radio access device and is transmitted periodically.

As described hitherto, the broadcast of the control messages, which are independently generated in each layer, increases an overhead in transmission and processing of control messages in the network and deteriorates the data transmission. Accordingly, it is strongly required to minimize the occurrence of the control messages.

### SUMMARY OF THE INVENTION

In view of the above, the present invention provides a technology to minimize the generation of routing control messages in a third layer of a cognitive radio (CR) ad-hoc networks, by utilizing function information generated in a second layer of the cognitive radio (CR) ad-hoc networks to update information about neighboring radio access devices and route information.

In accordance with an embodiment of the present invention, there is provided a radio access method for use in a radio access device in cognitive radio ad-hoc networks, which includes: comparing additional information about neighboring radio access devices, which exist in the cognitive radio ad-hoc networks, in a second layer of the radio access device with additional information about the neighboring radio access devices in a third layer of the radio access device in the cognitive radio ad-hoc networks; and generating a routing control message when the additional information of the second layer is different from the additional information of the third layer to broadcast the routing control message.

In the exemplary embodiment, the radio access method further comprising: when the additional information of the second layer is equal to the additional information of the third layer, extending an expiration time of the information of the neighboring radio access devices in the third layer.

In the exemplary embodiment, the radio access method further comprising: after broadcasting the routing control message, registering information about neighboring radio access devices, which are searched, as the additional information in the third layer.

In the exemplary embodiment, wherein said extending an expiration time is performed without generating any routing control message.

In the exemplary embodiment, wherein the additional information of the second layer includes additional information generated through the mutual exchange of beacon messages with the neighboring radio access devices.

In the exemplary embodiment, wherein the additional information of the second layer includes one or more of identification information of the neighboring radio access devices, interface information, channel information, or a lifetime.

In the exemplary embodiment, wherein the additional information of the third layer includes additional information generated through the mutual exchange of routing control messages with the neighboring radio access devices.

In the exemplary embodiment, wherein the additional information of the third layer includes one or more of identification information of the neighboring radio access devices, interface information, link type, or a lifetime.

In the exemplary embodiment, the radio access method further comprising: determining whether a period time for generating the routing control message arrives; and performing the comparison of the additional information when a period time for generating the routing control message arrives.

In the exemplary embodiment, wherein said broadcasting the routing control message comprises: comparing access information of the neighboring radio access devices through interfaces in the radio access device; calculating information about an interface having the maximum number of neighboring radio access devices connected thereto; deleting information of the neighboring radio access devices that are connected to the interface corresponding to the information of the interface that has been calculated; determining whether there exists the information of the neighboring radio access devices in the radio access device; and broadcasting the routing control message via the interface when there exists no information of the neighboring radio access devices in the radio access device.

In the exemplary embodiment, wherein the calculation of the information of an interface is performed using the following equations:

$${Interface}_{i} = \{ {e}_{kj} , {I}_{j} is neighbors of k via {interface}_{i} \} and$$

$${P}_{broadcast interface} = MAX ( {\sum }_{i = 0}^{the number of interfaces} n ( {interface}_{i} ) ) where {e}_{kj}$$

are links that connect a node k of the radio access device and nodes j of the neighboring radio access devices (0≦j≦the number of the neighbors), and Interfaceᵢ denotes information about an i-th interface of the node having the links eₖⱼ.

In the exemplary embodiment, wherein said calculating the information of an interface comprises: selecting one interface having the maximum number of the neighboring radio access devices connected thereto based on the equation of P_{broadcast interface}.

Accordingly, the embodiments of the present invention enable an individual radio access device to achieve the search of the neighboring radio access devices and the route search while reducing an amount of the routing control messages to be generated in the cognitive radio ad-hoc network environment. A method of the embodiments is implemented by utilizing a beacon message of existing wireless radios and is realized by simply configuring information about the neighbors between the second layer and the third layer and comparing the information therebetween. Particularly, in an environment having much control messages such as multi-interface multi-channel environment, it is possible to reduce the amount of the routing control messages. The reduction of the routing control messages leads to the decrease of the network congestion and the loss of transmission bandwidth, which enables a stable data transmission.

### BRIEF DESCRIPTION OF THE DRAWINGS

The above and other objects and features of the present invention will become apparent from the following description of the embodiments given in conjunction with the accompanying drawings, in which:

FIG. 1 is an illustrative diagram explaining the delivery of control messages in cognitive radio ad-hoc networks based on a multi-interface multi-channel in accordance with an embodiment of the present invention;

FIG. 2 is a functional diagram for different network layers in a radio access device applicable to an embodiment of the present invention;

FIG. 3 shows an exemplary information table for a second layer of a radio access device, which is built up using a beacon message in cognitive radio ad-hoc networks;

FIG. 4 shows an exemplary information table for a third layer of a neighboring radio access device, which is built up using a routing control message in cognitive radio ad-hoc networks;

FIG. 5 is a flow diagram illustrating a radio access method in cognitive radio ad-hoc networks in accordance with an embodiment of the present invention, which depicts a process of reducing the generation of control messages of a third layer through the use of an information table for the neighboring radio access devices of second layer;

FIG. 6 is a diagram of time-domain explaining a process of decreasing control messages of a third layer in a time domain in accordance with an embodiment of the present invention; and

FIG. 7 is a flow diagram illustrating a radio access method in cognitive radio ad-hoc networks in accordance with an embodiment of the present invention, which depicts a process of selecting the minimum number of transmission interfaces when multiple interfaces are connected with neighboring radio access devices via multiple channels.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims. Similar reference numerals refer to the same or similar elements throughout the drawings.

In the following description, well-known functions or constitutions will not be described in detail if they would unnecessarily obscure the embodiments of the invention.

Further, the terminologies to be described below are defined in consideration of functions in the invention and may vary depending on a user's or operator's intention or practice. Accordingly, the definition may be made on a basis of the content throughout the specification.

The combinations of the each block of the block diagram and each operation of the flow chart may be performed by computer program instructions. Because the computer program instructions may be loaded on a general purpose computer, a special purpose computer, or a processor of programmable data processing equipment, the instructions performed through the computer or the processor of the programmable data processing equipment may generate the means performing functions described in the each block of the block diagram and each operation of the flow chart. Because the computer program instructions may be stored in a computer usable memory or computer readable memory which is capable of intending to a computer or other programmable data processing equipment in order to embody a function in a specific way, the instructions stored in the computer usable memory or computer readable memory may produce a manufactured item involving the instruction means performing functions described in the each block of the block diagram and each operation of the flow chart. Because the computer program instructions may be loaded on the computer or other programmable data processing equipment, the instructions performed by the computer or programmable data processing equipment may provide the operations for executing the functions described in the each block of the block diagram and each operation of the flow chart by a series of functional operations being performed on the computer or programmable data processing equipment, thereby a process executed by a computer being generated.

Moreover, the respective blocks or the respective sequences in the appended drawings may indicate modules, segments, or some of codes including at least one executable instruction for executing a specific logical function(s). In several alternative embodiments, it is noticed that the functions described in the blocks or the sequences may run out of order. For example, two successive blocks and sequences may be substantially executed simultaneously or often in reverse order according to corresponding functions.

A radio access method in cognitive radio ad-hoc networks in accordance with an embodiment of the present invention may generally include the following functionalities:

(a) creating and managing information table for neighboring radio access devices through the use of a beacon message that is functional information of a second layer and is used to exchange available channels and auxiliary channels in cognitive radio ad-hoc networks;

(b) referring to additional information table for neighboring radio access devices contained in a second layer and is used to transmit a routing control message of a third layer;

(c) when the additional information between the second layer and the third layer is different from each other, transmitting the routing control message of the third layer to newly search neighboring radio access devices and then registering the neighboring radio access devices that are newly searched as the information of the neighboring radio access devices in the third layer; and (d) when the additional information between the second layer and the third layer is equal with each other, extending an expiration time of the information of the neighboring radio access devices in the third layer to a predetermined time.

Further, the radio access method in the cognitive radio ad-hoc networks may further include exchanging the routing control messages of the third layer using the minimum number of interfaces in a situation where multiple interfaces connect to the neighboring radio access devices via multiple channels, in exchanging messages for each interface in the radio access device.

Hereinafter, the embodiments of the present invention will be described in detail with reference to the accompanying drawings.

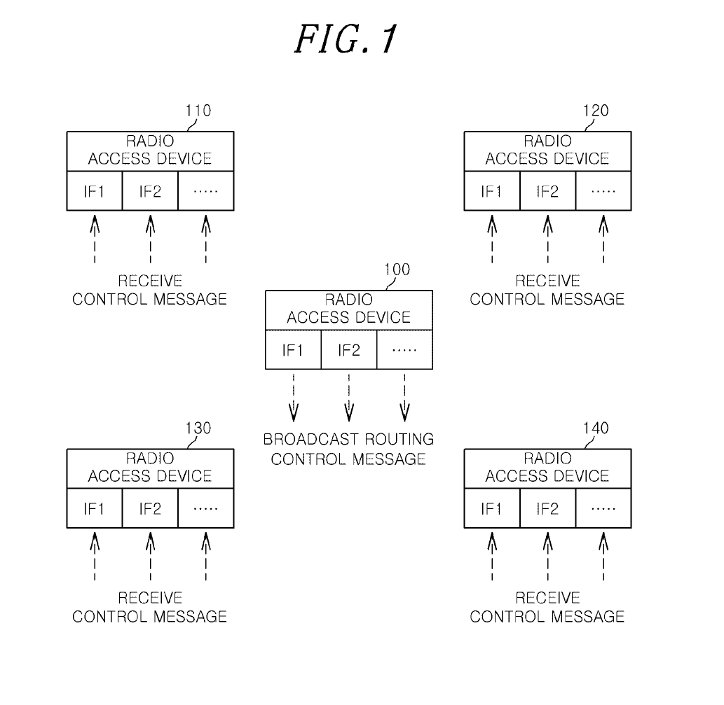

FIG. 1 is an illustrative diagram explaining the delivery of routing control messages in cognitive radio ad-hoc networks based on multi-interface multi-channel, which depicts a cognitive ad-hoc network environment explaining a radio access technology in accordance with an embodiment of the present invention.

As illustrated in FIG. 1, each of radio access devices 100, 110, 120, 130 and 140 include a number of wireless interfaces IF1, IF2, . . . . All of the radio access devices periodically broadcast routing control messages in order to search their routes and neighboring radio access devices. The number of the routing control messages that are broadcasted increases or decreases depending on the number of the wireless interfaces and the broadcasting period. The routing control messages have the same contents in each broadcasting period.

Referring to FIG. 1, during a specific radio access device, for example, a first radio access device 100 broadcasts a routing control message, remaining radio access devices within a transmission coverage of the first radio access device 100, for example, the radio access devices 110, 120, 130, and 140 are not allowed to broadcast their routing control messages and to transmit data, but to receive signals. The broadcast of the routing control message enables the respective radio access devices not only to configure information about neighboring radio access devices, but also to search routes.

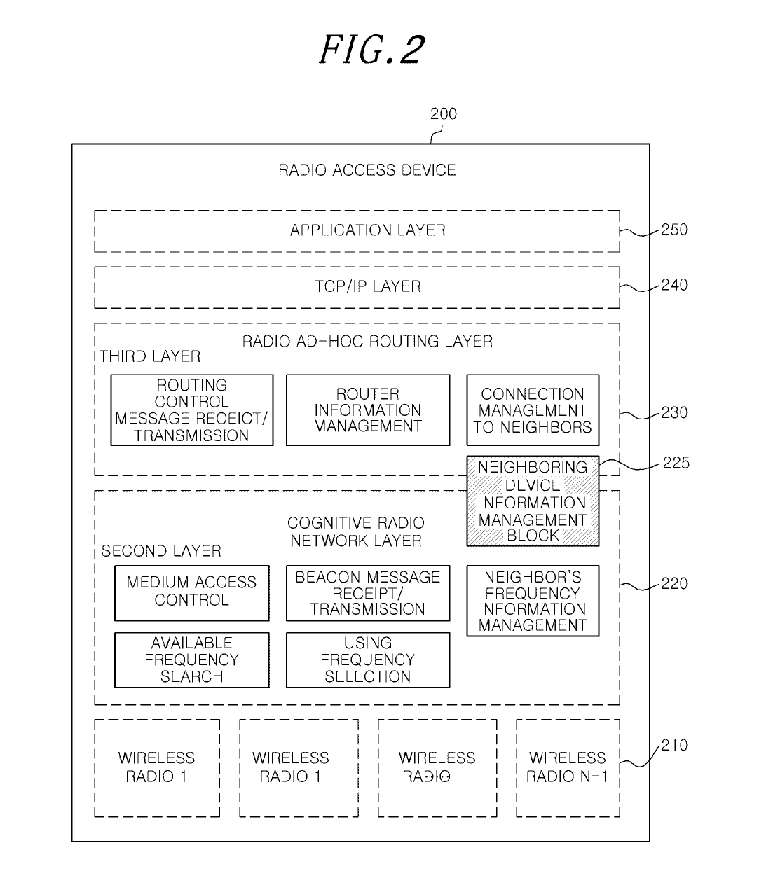

FIG. 2 is a functional diagram for different network layers in a radio access device 200 which may be applicable to an embodiment of the present invention, wherein the radio access device may include a number of network layers and each of the network layers contains a plurality of information.

Referring to FIG. 2, for example, in cognitive radio ad-hoc networks, the radio access device 200 is made up of a first layer 210 having a plurality of wireless radios, a second layer 220 which is a cognitive radio network layer, a third layer 230 which is a radio ad-hoc routing layer, a fourth layer which is TCP/IP (Transmission Control Protocol/Internet Protocol) layer, and a fifth layer which is an application layer.

Further, the radio access device 200 includes neighboring device information management block 225 for comparing neighboring device information between the second layer 220 and the third layer 230.

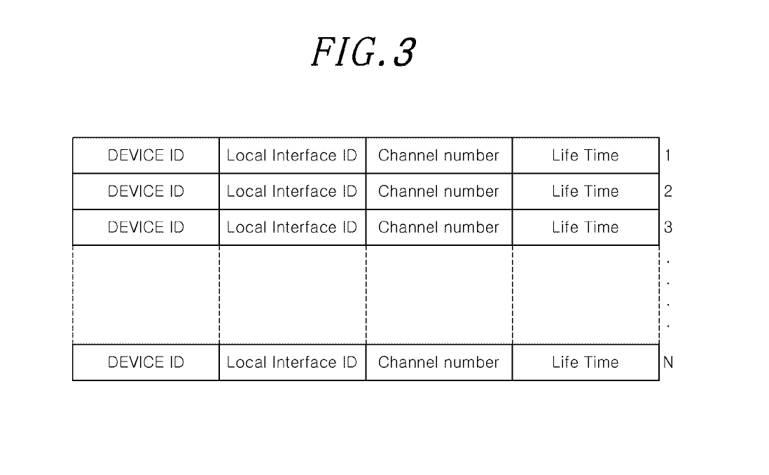

FIG. 3 shows an additional information table for the radio access device 200 contained in the second layer, shown in FIG. 2, in the cognitive radio ad-hoc networks.

In the second layer 220 which is the cognitive radio network layer, a beacon message is periodically transmitted in order to select an available channel (frequency) between the neighboring radio access devices.

In accordance with the embodiment of the present invention, the radio access device 200 may store additional information generated during the exchange of the beacon messages with the neighboring radio access devices. The addition information may be classified and stored, for example, on an identification information basis such as an IP addresses, a MAC addresses and the like.

As illustrated in FIG. 3, the additional information in the second layer 220 may include one or more of identification information (DEVICE ID) of each neighboring radio access device, its interface information (Local Interface ID) or channel information (Channel Number) employed for communicating the beacon message with each neighboring radio access device, and an expiration time the information (Life Time).

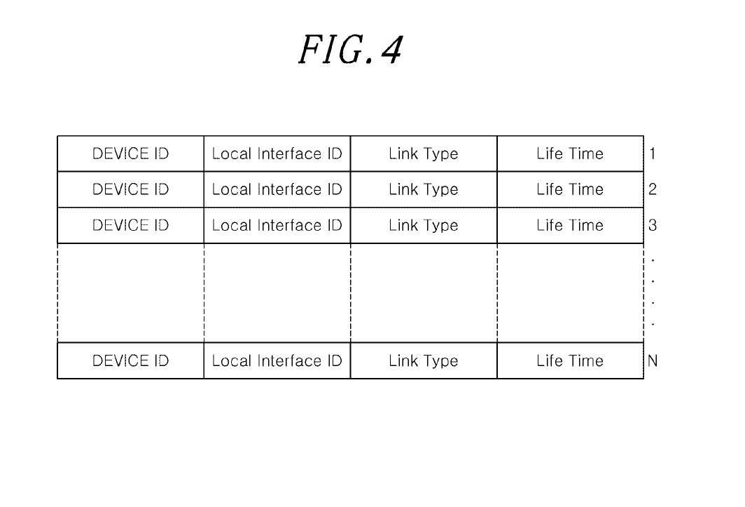

FIG. 4 shows an exemplary additional information table for the third radio access device 200 contained in the third layer 230 in the cognitive radio ad-hoc networks.

In the third layer 230 which is a radio ad-hoc routing layer, additional information of the neighboring radio access devices may be configured by storing it during a radio routing procedure through the use of a routing control message, e.g., a HELLO message, which is functionality information.

As illustrated in FIG. 4, the additional information contained in the third layer 230 of the radio access device 200 may include one or more of identification information (DEVICE ID) of the neighboring radio access devices, its interface information (Local Interface ID) employed for communicating the routing control message with the neighboring radio access devices, a type of links (Link Type) that are connected to the neighboring radio access devices, and an expiration time (Life Time) of the information.

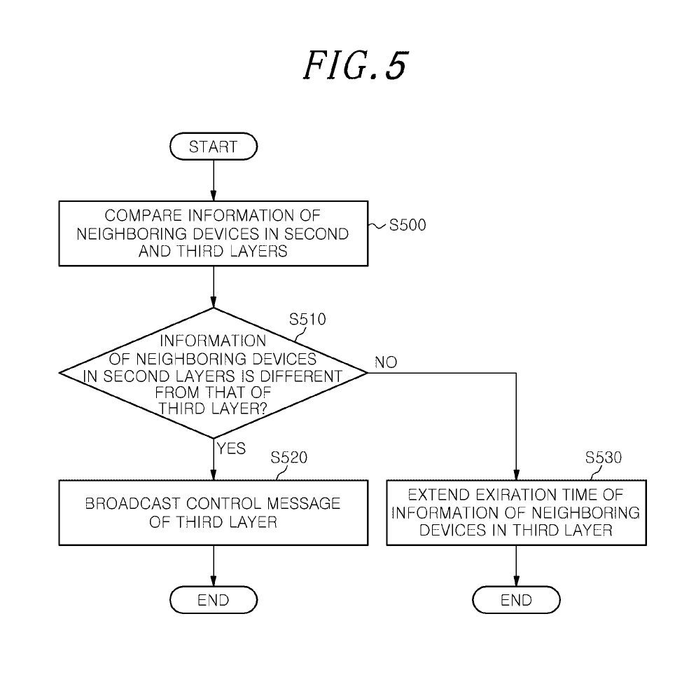

FIG. 5 is a flow diagram illustrating a radio access method in the cognitive radio ad-hoc networks in accordance with an embodiment of the present invention, which depicts a process of reducing the generation of control messages of the third layer by utilizing the additional information table in the second layer.

Referring to FIG. 5, each radio access device determines whether a scheduled time arrives or it is a time for generation period of a routing control message that has been registered as an event. When it is a time for generation period of the routing control message, the radio access device compares the additional information, i.e., the additional information of the neighboring radio access devices in the second layer and the third layer (Block S500).

For example, the radio access device 200 may compare the additional information shown in FIG. 3, which is generated during the mutual exchange of the beacon messages of the second layer 220, and the additional information shown in FIG. 4, which is generated during the mutual exchange of the routing control messages of the third layer 230.

When there is a difference between the additional information in the second layer 220 and the additional information in the third layer 230, for example, a list of DEVICE IDs of the neighboring radio access devices contained in the second layer 220 is different from that of the third layer 230 (Block S510), the routing control message of the third layer 230 is generated and broadcasted to the neighboring radio access devices (Block S520). Consequently, a control message can be transmitted to the neighboring radio access devices for the purpose of the generation of bi-directional links with neighboring radio access devices that are newly searched, and Information about the neighboring radio access devices that are newly searched are registered as the additional information in the third layer.

Meanwhile, when the additional information in the second layer 220 is the same as the additional information in the third layer 230, the radio access device 200 extends an expiration time of the information about the neighboring radio access devices in the third layer 230 (Block S530). In this case, the radio access device 200 will not generate the routing control message of the third layer 230.

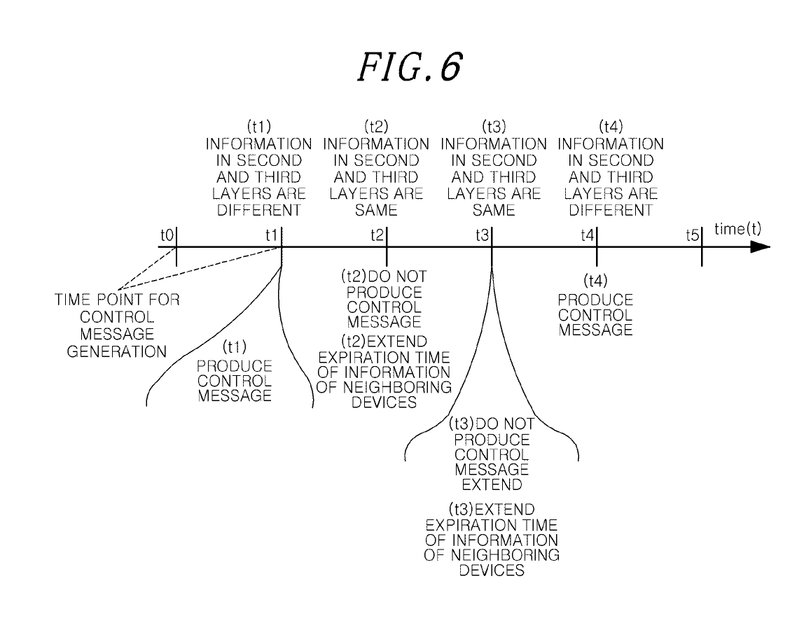

FIG. 6 is a diagram of time-domain explaining a process of reducing the control message of the third layer in accordance with an embodiment of the present invention.

First, the routing control message is configured to have a predetermined generation period or it is scheduled to generate by an event. The routing control message is transmitted to the cognitive ad-hoc networks in the broadcast manner every period.

As illustrated in FIG. 6, while a conventional art needs to broadcast a routing control message every period within an entire duration time T, the embodiment of the present invention is characterized in that the radio access device compares the additional information between the second layer and the third layer and generates the routing control message to broadcast it at only time points t1 and t4 when the additional information are not equal to with each other.

The additional information in the second layer is equal to that of the third layer at remaining time points, t0, t2, t3, and t5, and thus, the radio access device expends an expiration time of the information about the neighboring radio access devices in the third layer.

In other words, the embodiment of the present invention implements a radio access method which produce the routing control message and broadcast the same only when the additional information in the second layer is different to that of the third layer, rather than to produce and broadcast the routing control message depending on every period of generating the routing control message, which leads to the minimization of network congestion and the loss of transmission bandwidth, thereby making a stable data transmission.

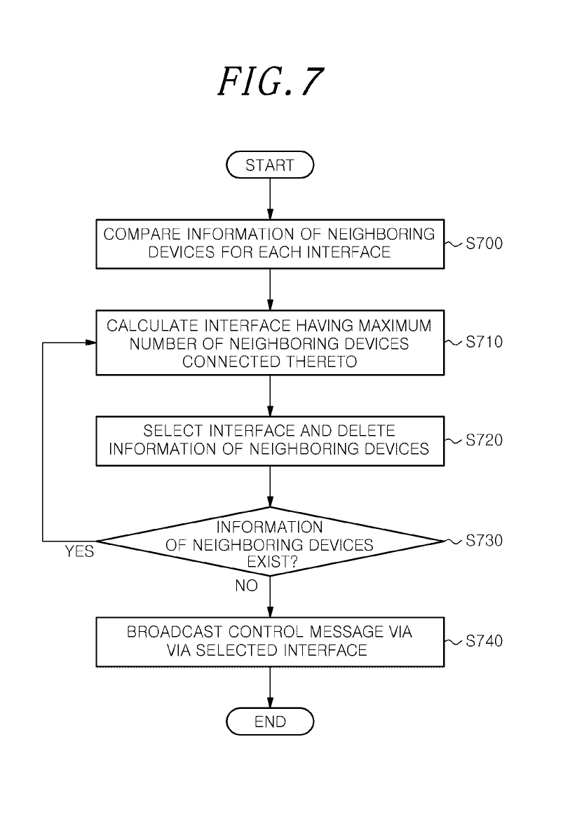

FIG. 7 is a flow diagram illustrating a radio access method in the cognitive radio ad-hoc networks in accordance with an embodiment of the present invention, which depicts a process of selecting local interfaces (i.e., the minimum number of transmission interfaces) dedicated to transmit the control message when multiple interfaces are connected to the neighboring radio access devices via multiple channels.

Referring to FIG. 7, each of the local interfaces in the radio access device compares access information to the neighboring radio access devices (Block S700).

Calculation is made for selecting an interface which has the maximum number of the neighboring radio access devices connected thereto (Block S710).

Such a calculation is carried out by the following Equation 1.

$$\begin{matrix}{Interface}_{i} = \{ {e}_{kj} , {I}_{j} is neighbors of k via {interface}_{i} \} & [ Equation 1 ] \\ {P}_{broadcast interface} = MAX ( {\sum }_{i = 0}^{the number of interfaces} n ( {interface}_{i} ) ) & [ Equation 2 ]\end{matrix}$$

In the Equation 1, Interfaceᵢ denotes information about an i-th interface of a node k of a corresponding radio access device having links eₖⱼ that connect the node k and nodes j of the neighboring radio access devices (0≦j≦the number of the neighbors). Based on the Equation 2 of Pbroadcastinterface, it is possible to select one interface to which the maximum number of the neighboring radio access devices are connected.

Once the one interface is selected, the information of the neighboring radio access devices connected to the selected interface is deleted from the additional information table (Block S720).

If there remains the information of the neighboring radio access devices in the radio access device, the process returns to and repeats Block S710 to Block S720, otherwise the calculation is ended. Subsequently, the routing control message is broadcasted via the selected interface (Block S740).

As mentioned earlier, in accordance with an embodiment of the present invention, it is possible to achieve the search of the neighboring radio access devices and the route search while reducing an amount of the routing control messages to be generated in an cognitive radio ad-hoc network environment. The embodiment is implemented by utilizing a beacon message of existing wireless radios and is realized by simply configuring information about the neighboring access devices between the second and the third layer and comparing the information therebetween. Particularly, in an environment having much control messages such as a multi-interface multi-channel environment, it is possible to reduce the amount of the routing control messages. The reduction of the routing control messages leads to the decrease of the network congestion and the loss of transmission bandwidth, which enables a stable data transmission.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A radio access method for use in a radio access device in cognitive radio ad-hoc networks, the radio access method comprising:
comparing additional information about neighboring radio access devices, which exist in the cognitive radio ad-hoc networks, in a second layer of the radio access device with additional information about the neighboring radio access devices in a third layer of the radio access device in the cognitive radio ad-hoc networks; and
generating a routing control message when the additional information of the second layer is different from the additional information of the third layer to broadcast the routing control message.

2. The radio access method of claim 1, further comprising:
when the additional information of the second layer is equal to the additional information of the third layer, extending an expiration time of the information of the neighboring radio access devices in the third layer.

3. The radio access method of claim 1, further comprising:
after broadcasting the routing control message, registering information about neighboring radio access devices, which are searched, as the additional information in the third layer.

4. The radio access method of claim 2, wherein said extending an expiration time is performed without generating any routing control message.

5. The radio access method of claim 1, wherein the additional information of the second layer includes additional information generated through the mutual exchange of beacon messages with the neighboring radio access devices.

6. The radio access method of claim 5, wherein the additional information of the second layer includes one or more of identification information of the neighboring radio access devices, interface information, channel information, or a lifetime.

7. The radio access method of claim 1, wherein the additional information of the third layer includes additional information generated through the mutual exchange of routing control messages with the neighboring radio access devices.

8. The radio access method of claim 7, wherein the additional information of the third layer includes one or more of identification information of the neighboring radio access devices, interface information, link type, or a lifetime.

9. The radio access method of claim 1, further comprising:
determining whether a period time for generating the routing control message arrives; and
performing the comparison of the additional information when a period time for generating the routing control message arrives.

10. The radio access method of claim 1, wherein said broadcasting the routing control message comprises:
comparing access information of the neighboring radio access devices through interfaces in the radio access device;
calculating information about an interface having the maximum number of neighboring radio access devices connected thereto;
deleting information of the neighboring radio access devices that are connected to the interface corresponding to the information of the interface that has been calculated;
determining whether there exists the information of the neighboring radio access devices in the radio access device; and
broadcasting the routing control message via the interface when there exists no information of the neighboring radio access devices in the radio access device.

11. The radio access method of claim 10, wherein the calculation of the information of an interface is performed using the following equations:
$${Interface}_{i} = \{ {e}_{kj} , {I}_{j} is neighbors of k via {interface}_{i} \} and$$
$${P}_{broadcast interface} = MAX ( {\sum }_{i = 0}^{the number of interfaces} n ( {interface}_{i} ) )$$
where eₖⱼ are links that connect a node k of the radio access device and nodes j of the neighboring radio access devices (0≦j≦the number of the neighbors), and Interfaceᵢ denotes information about an i-th interface of the node having the links eₖⱼ.

12. The radio access method of claim 11, wherein said calculating the information of an interface comprises:
selecting one interface having the maximum number of the neighboring radio access devices connected thereto based on the equation of P_{broadcast interface}.
